(19) United States
(12) Patent Application Publication
(10) Pub. No.: US 2009/0019701 A1
(43) Pub. Date: Jan. 22, 2009

(54) Safety razors

(76) Inventors: Graham John Simms, Berkshire (GB); Robert Barrett Yates, Berkshire (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/283,642

(22) Filed: Sep. 15, 2008

Related U.S. Application Data
(62) Division of application No. 11/203,446, filed on Aug. 12, 2005.

(30) Foreign Application Priority Data
Feb. 19, 2003 (GB) 0303869.2
Feb. 19, 2004 (WO) WO 2004/073938 A1

(51) Int. Cl. B26B 21/00

(52) U.S. Cl. 30/32

(57) ABSTRACT

The invention relates to safety razors that include a blade unit carried on a handle, a vibration device powered by a battery under control of a control device, and a switch, e.g., included in the handle, to switch on and off an electrical connection between the battery and the control device; a storage tray on which the razor is stored when not in use including a magnet so that the switch closes a connection between the battery and the control device when the razor is separated from the storage tray; and a timing device to interrupt the supply of power to the electrical arrangement if the razor is not returned to the razor holder within a predetermined time period after being removed from the razor holder.

### CROSS REFERENCE TO RELATED APPLICATIONS

This application is a division application of U.S. application Ser. No. 11/203,446 filed on Aug. 12, 2005; which is a continuation of WO 2004/073938 A1, filed on Feb. 19, 2004, which claims priority from GB 0303869.2, filed on Feb. 19, 2003.

### TECHNICAL FIELD

This invention relates to safety razors.

### BACKGROUND

A safety razor generally includes a handle and a blade unit carried on the handle and including at least one blade with a sharp cutting edge. In the course of shaving, the blade unit is applied against the skin and the blade or blades are moved across the skin so that the sharp cutting edges engage and cut through hairs protruding from the skin.

The blade unit can be fixed on the handle with the intention that the entire razor should be discarded when the cutting edges have become dull and are no longer capable of providing a comfortable shave. Alternatively, the blade unit may be removably mounted on the handle so that the blade unit can be replaced by a new blade unit when the sharpness of the blades has diminished to an unacceptable level. Replaceable blade units are often referred to as shaving cartridges.

The majority of safety razors currently marketed are operated and used entirely manually. Nonetheless electrical devices can be incorporated in safety razors. For instance it is known to include an electrically driven vibration mechanism that is operable to vibrate the razor, it having been observed that such vibration can have a beneficial effect on razor performance. A simple and convenient vibration generating mechanism consists of an electric motor with a weight mounted eccentrically on its output shaft. The vibration mechanism and a battery for providing electric power to the motor can be conveniently housed in the razor handle. Examples of previous proposals for such razors are those described in U.S. Pat. No. 5,299,354, U.S. Pat. No. 5,214,851, and U.S. Pat. No. 5,046,249. A safety razor incorporating a vibration mechanism is also described in U.S. Pat. No. 6,481,104B1 and this razor is provided with a holder including a suction cup and a magnet for storing the razor, such as on a mirror, when the razor is not being used. The vibration mechanism is controlled by a manual switch on the razor housing.

A vibration mechanism may be adapted to vibrate only one or more selected components of the blade unit, such as the guard which contacts the skin in front of the blades, or one or more blades, and the vibration may be directional, for instance directed lengthwise of the blades to encourage a slicing cutting action or transverse to the blades. Another possibility is for an element to be vibrated in a direction generally perpendicular to the skin surface being shaved. The vibration mechanism may incorporate a piezoelectric device for producing the vibrations, instead of a motor for rotationally driving an eccentric weight.

Other forms of electrical devices besides vibration generators may be included in wet razors, some examples of such devices being: (i) heating devices for heating one or more blades or other components of a blade unit which contact the skin during shaving, such as Peltier devices or electrical resistance or ohmic heating devices; (ii) dispensing devices for delivering a shaving enhancement product to the skin and which may be activated by operation of a motor driven pump or by operation of a valve having an electrically controlled actuator, shaving enhancement products that can be delivered at a safety razor blade unit during performance of a shaving stroke including those with the qualities and properties mentioned in our patent application No. WO 00/47374, the contents of which are incorporated herein by reference in their entirety; (iii) conditioning devices to prepare the skin and/or hairs ready to be cut by the blades, such as a roller mounted in the region of the guard of the blade unit and adapted to be rotated about its axis for encouraging hairs lying against the skin to stand up for cutting; iv) illumination devices for illuminating an area of skin being shaved; and v) actuators for adjusting the blade unit in accordance with prevailing shaving conditions detected by a sensor.

In EP-A-0906814 and U.S. Publication No. 2002/0189102 there are described razors with force sensors and electronically activated indicators to signal that blade replacement is necessary.

Whatever the particular form of the electrical device included in a wet razor, a switch to control the supply of electrical power delivered from a power source, especially if that source is a replaceable or rechargeable battery, is desirable. Manually operated switches have been proposed and used hitherto, but they rely on the razor user remembering to turn the power supply on and off at appropriate times for proper operation of the electrical device and to ensure that electrical energy is not consumed unnecessarily.

There is disclosed in U.S. Pat. No. 4,493,975 an electric appliance safety system in which a so-called hanger box on which the appliance, in particular a hair dryer, is stored during periods of none use includes a switch device that must be operated manually after removal of the dryer to supply power to the dryer, which is connected to the hanger box by a power cable, the switch being operated to turn off the power supply when the dryer is replaced on the hanger box. In U.S. Pat. No. 4,366,366 and U.S. Pat. No. 1,681,291 there are described support devices for smoothing irons in which devices to control power supply to the irons, which are connected to the devices by power cables are provided. The use of power cables is an inconvenience and inappropriate for battery powered devices in a portable appliance.

### SUMMARY

In view of the foregoing, there is proposed in accordance with the present invention a safety razor including a blade unit having at least one blade with a sharp cutting edge, a handle on which the blade unit is carried, a power switch, and an electrical arrangement operable during shaving and connectable to a power source via the power switch, the power switch being arranged to be operated to permit power delivery from the power source to the electrical arrangement by separation of the razor from a holder on which the razor is stored during periods of non-use.

The power switch is conveniently included in the handle of the razor. The power switch can be a mechanical switch positioned on the handle to be actuated by engagement with and disengagement from the razor holder. In another embodiment, the power switch is magnetically actuable, for example a reed switch, and the razor holder includes a magnet for the switch to be operated when the razor is separated from and placed onto the razor holder.

The razor holder is preferably arranged to grip the handle at or adjacent to the location of the power switch, which can help in assuring proper operation of the power switch. The razor holder may have the form of a tray for the razor to lie on, e.g., of the general form described in U.S. Pat. No. 5,782,346.

In certain embodiments the electrical arrangement includes an electrical device and a control device to control operation of the electrical device response to a predetermined condition being sensed by the control device, e.g., the blade unit being brought into contact with, or into close proximity to, the skin surface of a person holding the razor, and/or the blade unit being immersed into a body of water for cleaning the blade unit. When the power switch is turned on to supply power to the control device from the power supply, such as a battery, which can be conveniently housed in the handle, but power is not immediately delivered to the electrical device, the razor will be in a standby mode and fully prepared for use, and this can be signaled to the user by an indicator, e.g., a light emitting device carried by the handle or a sound or tone generator for producing an audible signal. The same or a further light emitting device may be arranged to flash when battery power is low.

The invention is specifically described herein below with reference to an embodiment in which the electrical device controlled by the control device is a vibration generator, for example, a motor with an eccentric weight fastened to its output shaft. Other forms of electrical devices, including those mentioned herein can be provided alternatively or additionally.

In certain embodiments, a timing device can be provided to interrupt the supply of power to the electrical arrangement if the razor is not returned to the razor holder within a certain period of time after being removed from the razor holder. A timing device helps avoid unnecessary expenditure of energy if a razor user fails to return the razor to the holder after use. The timing device can be re-settable by placing the razor on the holder once again.

### DESCRIPTION OF DRAWINGS

To facilitate a clear understanding of the invention, an embodiment is described in detail below with reference to the accompanying drawings, in which:

FIG. 1 is a partial isometric view of the razor illustrating the blade unit and an upper portion of the handle as seen from the rear;

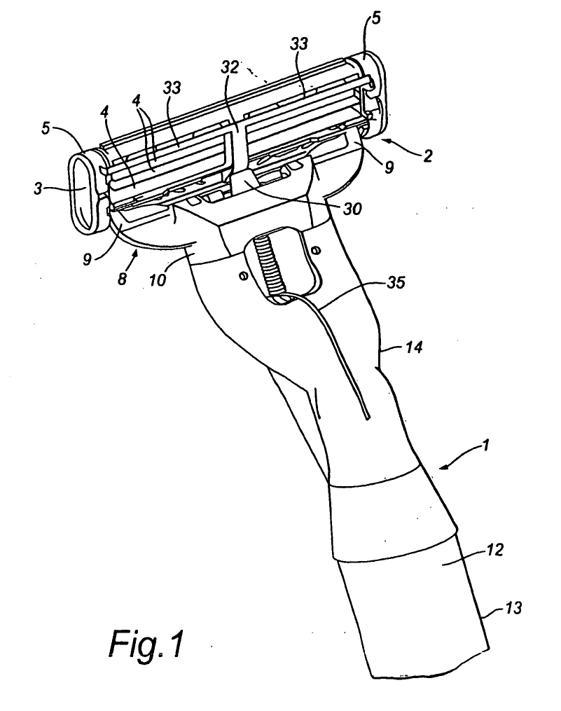

FIG. 2 shows the razor in rear elevation;

FIG. 3 is a side elevation showing a razor holder in the form of a tray on which the razor is stored during periods of non-use, the razor being shown separated from the storage tray at a small distance;

FIG. 4 is a side elevation corresponding to claim 3, but showing the razor at a greater distance form the storage tray;

FIG. 5 shows the razor and storage tray of FIG. 3 in an isometric view;

FIG. 6 is an exploded rear elevation of the razor;

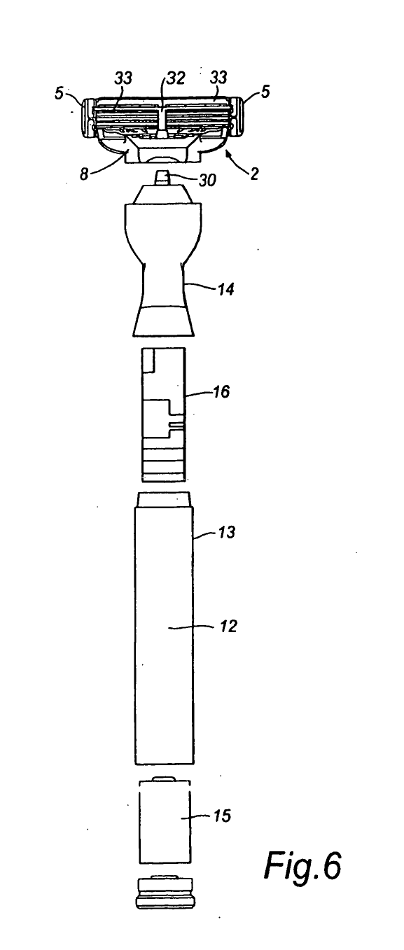

FIG. 7 is a rear elevation of the razor illustrating an additional element of the water detecting arrangement;

FIG. 8 is a block diagram of an electronic control device incorporated in the razor; and

FIG. 9 shows an example of a specific embodiment of a control circuit.

Like reference symbols in the various drawings indicate like elements.

### DETAILED DESCRIPTION

The safety razor illustrated in the drawings has a handle 1 and a blade unit or cartridge 2 detachably mounted on the upper end of the handle. The blade unit 2 includes a generally rectangular frame 3, and a plurality of blades 4, e.g., 3, 4 or 5 blades with substantially parallel sharp cutting edges, disposed in the frame and held in place by metal clips 5 positioned around the frame 3 at the opposite ends of the blade unit 2. A guard structure including a strip of elastomeric material is provided on the frame for contacting the skin in front of the blades, and a cap structure including a lubricating strip is provided on the frame for contacting the skin behind the blades during the performance of a shaving stroke. The frame is pivotally carried on a yoke member 8 having a pair of arms 9 that extend from a hub 10 and are journalled in opposite ends of the frame 2 so that the blade unit 2 can pivot relative to the handle 1 about an axis substantially parallel to the blade edges. The hub 10 is connected detachably to the end of the handle 1. As so far described the razor is of a known construction and for further details reference may be made to earlier patent publications, one example of which is WO 97/37819, which is incorporated herein by reference in its entirety.

The razor handle includes a main portion 12 intended to be gripped in the hand and a neck 14 extending upwardly from the main portion and to the free end of which the blade unit 2 is attached. The main or gripping portion 12 of the handle 1 includes an electrically conductive, e.g., metal casing 13, which serves as an electrode for electrical contact with the hand of a user as described in more detail below. Housed within a battery compartment in the handle is a replaceable or rechargeable battery 15, which constitutes a power supply for an electronic control device 16 also accommodated within the handle.

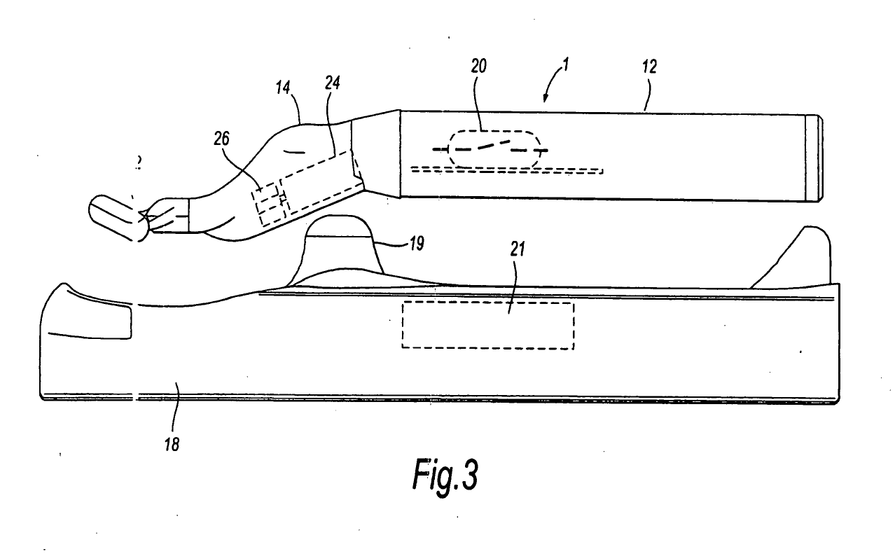

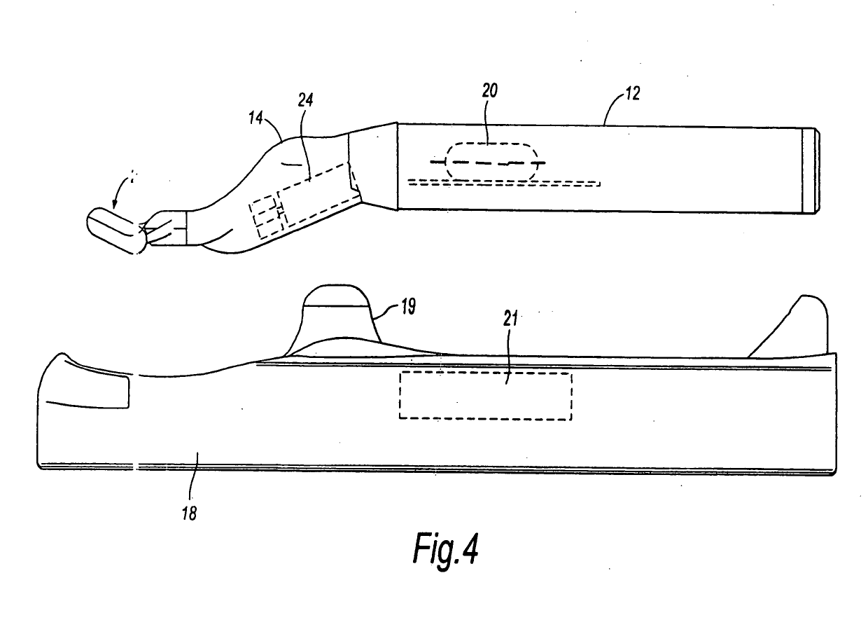

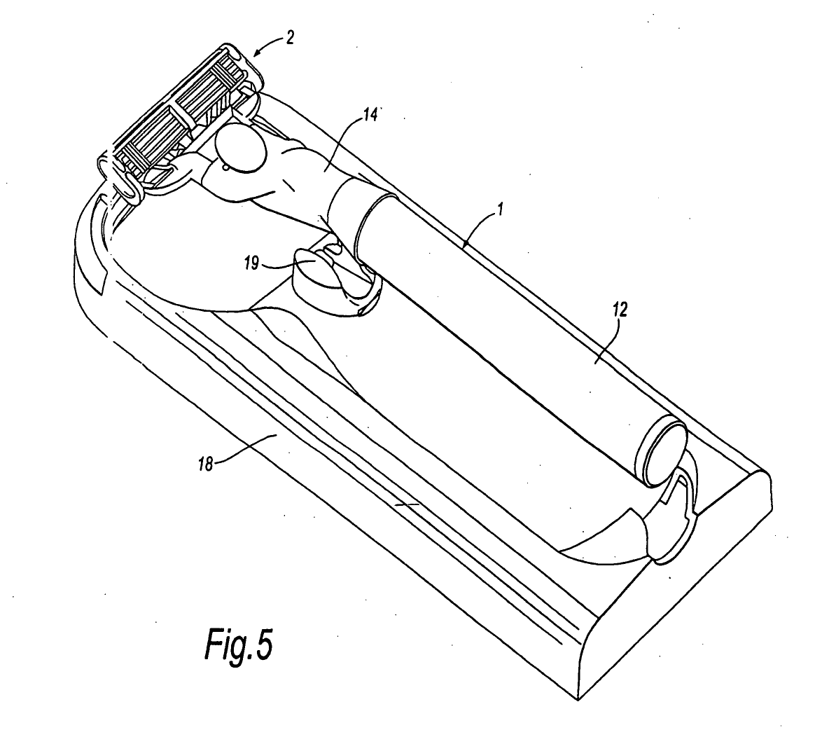

In accordance with the present invention the battery 15 is electrically connected to the control device 16 through a power switch that is operable to interrupt power supply to the control device for conserving battery energy during periods when the razor is not being used. The power switch is arranged to be actuated by removing the razor from, and returning it to, a razor holder on which the razor is intended to be stored when not in use. A known form of razor holder consists of a tray 18 as shown in FIGS. 3-5, the tray 18 having on its upper side a saddle 19 adapted to receive and lightly grip the neck 14 of the razor handle 1. The razor handle 1 can be equipped with a mechanical switch so arranged for cooperation with the storage tray 18 that the switch is operated automatically when the razor is lifted away from the storage tray 18 for power to be supplied to the control device 16 from the battery 15, and to be actuated upon replacement of the razor on the tray to interrupt the power supply. In certain embodiments, essentially the same result is achieved by a power switch in the form of a reed switch 20 located within the handle 1, the storage tray 18 being provided with a permanent magnet 21. The magnet is located in a position close to the saddle 19, and the reed switch is disposed in the handle 1 at or adjacent to the portion of the neck 14 adapted to be gripped in the saddle. When the razor is positioned close to the tray 18 the reed switch 20 is held open and there is no electrical power supply from the battery 15, as shown in FIG. 3, but when the razor is moved away from the tray the reed switch 20 closes and electrical power supply to the control device 16 is established.

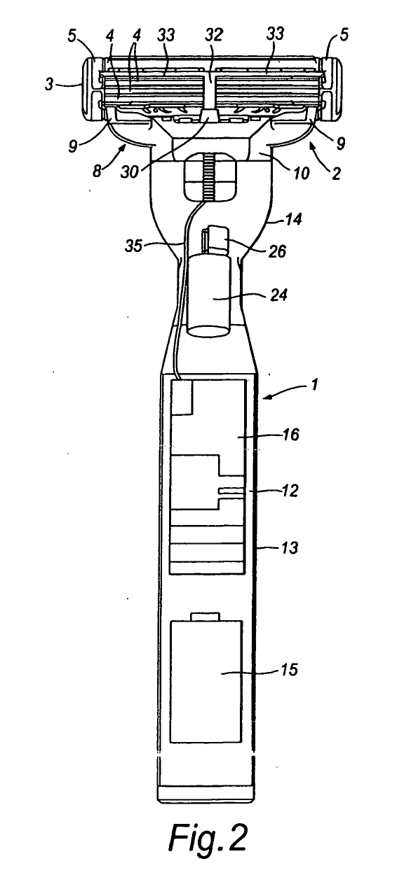

The control device 16, in a manner described in detail below, controls actuation of an electric motor 24 (FIGS. 2 and 3) housed within the handle 1 and having an output shaft with an eccentric weight 26 fastened thereon. In a manner known per se, energization of the electric motor results in a high speed rotation of the eccentric weight 26 and thereby vibration of the razor, and the blade unit 2 in particular. A suitable vibration frequency is around 120 Hz.

The blade unit 2 incorporates an electrode that is conveniently constituted by at least one and preferably includes all of the blades 4 of the blade unit. Electrical connection between the control device and this electrode 4 is achieved by the neck 14 of the handle 1 having a contact 30 arranged to project through the hub 10 of the yoke member 8 and to bear against a contact strip 32 fixed to the rear of the blade unit 2, the contact strip 32 having lateral wings 33 which extends to and are conductively connected to the metal blade retention clips 5, and these clips in turn having contact with blades 4. Of course, it is not essential to use the blades 4 as an electrode and a separate electrically conductive element could be provided on the blade unit in a position for contacting the skin when the blade unit 2 performs a shaving stroke. The contact 30 makes constant electrical contact with the contact strip 32 so that the electrical continuity between the electrode at the blade unit is not interrupted even during pivoting of the blade unit 2 on the handle 1 as tends to occur as the blade unit is applied to and moved across the skin. The contact 30 conveniently takes the form of a spring-loaded plunger for resisting pivotal movement of the blade unit away from a predetermined rest position. The contact 30 is shown connected electrically to the control device 16 by a wire conductor 35 which is led through the neck 14 of the handle 1.

Of course, there are other possibilities to ensure electrical connection of the electrode on the blade unit and the control device. For example, the frame 3 of the blade unit could be made of an electrically conductive material, such as a conductive plastic. Also the rear of the frame 3 could be plated, coated, or printed with conductive material, have an adhesive metal foil applied to it, or have a metal element embedded therein, to provide electrical connection between the contact 30 and the clips 5, or to the electrode itself or another component in contact with the electrode. Alternatively, the frame can include an injection molded metal part to provide the conductive path between the electrode and the contact 30, or water held in capillary grooves may be sufficient to ensure the electrical continuity.

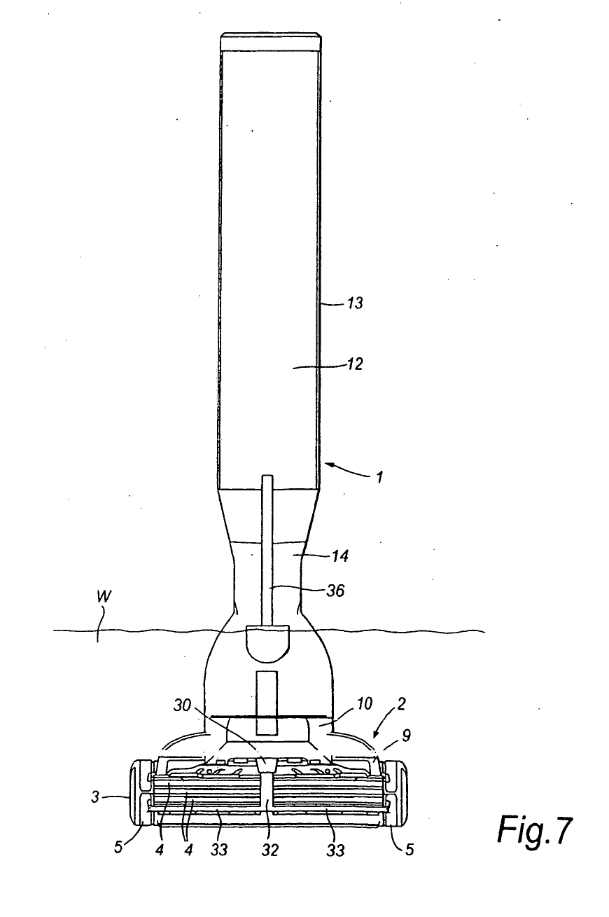

It is possible for the control device 16 to be arranged to determine when the blade unit is immersed in water by sensing an electrical parameter between the electrode 4 on the blade unit 2 and the electrode formed by metal casing 13 of the handle gripping portion 12. It is not necessarily essential for the blade unit 2 to be plunged into water so deeply that the water must contact the handle gripping portion 12 for the immersion of the blade unit into the water to be detected, as may be the case if it is known the body of water will be connected to earth and the casing of the gripping portion handle will also be connected to earth, such as by the razor user. As illustrated in FIG. 7, however, the razor includes a water detection probe 36, which extends along the exterior of the neck 14 of the handle. The probe 36 is electrically conductive and serves as an electrode, or an electrode extension in as much that it can be electrically connected to the metal casing 13 of the handle gripping portion 12. A separate electrical connection between the probe 36 and the control device 16 can alternatively be used.

The control device 16 senses an electrical parameter, which may be electrical resistance or capacitance, between the blade electrode 4 and the probe electrode 36, and is responsive thereto to actuate the electric motor 24 to activate the vibration generator 26 when the blade unit 2 is immersed into a body of water W so that both electrodes make contact with the water. The control device operates to turn off the power supply to the motor 24 when the blade unit 2 is lifted out of the water W. The operation of the control device 16 is described in detail below. In certain embodiments of the invention, the control device 16 also functions as a touch sensitive device so that the motor 24 is actuated to drive a vibration generating eccentric weight 26 when a person holding the razor by the handle touches the blade unit 2 against the skin surface, e.g., at the start of a shaving stroke.

Vibrating the blade unit as it moves across the skin can have a beneficial effect on the shaving performance. However, as soon as the blade unit is lifted away from the skin surface the vibration stops. It has been found that the discomfort perceived by users of vibrating razors applies for the most part only when the razor is held with the blade unit away from the body in free space and by the vibration occurring only when the razor is actually shaving and during rinsing of the blade unit, the user prejudices against vibrating razors are mostly eliminated.

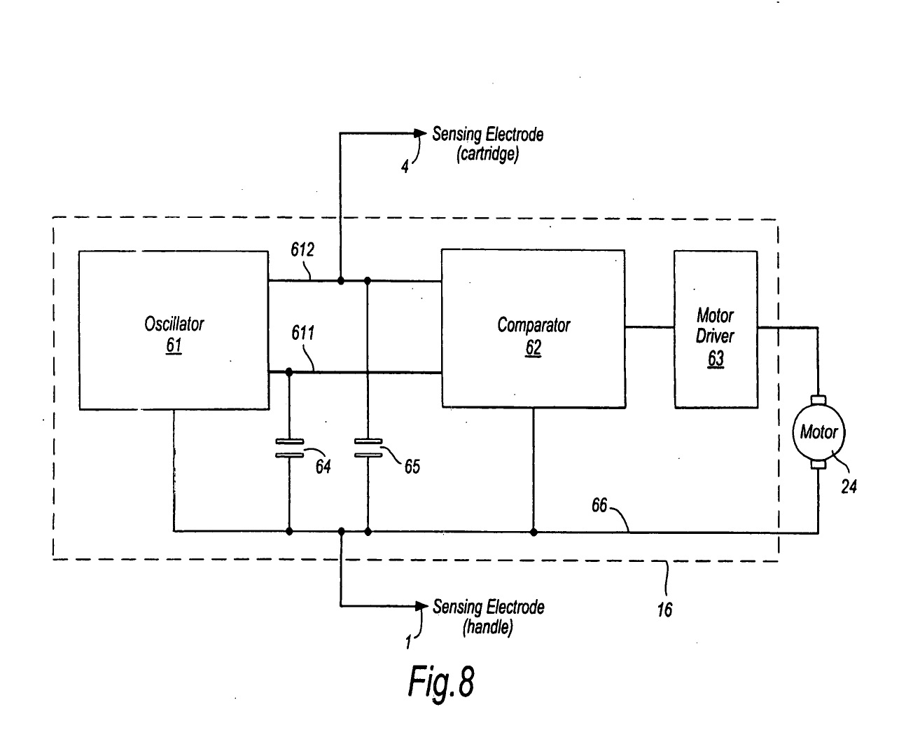

FIG. 8 is a schematic diagram to illustrate the function of control device 16. As shown, control device 16 includes oscillator 61, a comparator 62, motor driving circuitry 63 and first and second capacitors 64, 65. Control device 16 is additionally connected to two sensing electrodes, which may be constituted by the blades 4 and the exterior casing 13 of the handle 1 respectively, or may be provided elsewhere on the exterior of the razor according to which condition is desired to be sensed. Motor driving circuitry 63 is connected to provide the drive current to motor 24. As mentioned above, the power necessary to energize control device 16 is provided by battery 15 through a power switch. The power connections are omitted from FIG. 8 for clarity, it being understood that the following description of the operation of control device 16 is applicable to the condition when it is energized by the application of power from the battery.

Oscillator 61 is configured to provide two oscillating signals on output lines 611 and 612, respectively. Output lines 611 and 612 are connected to line 66, which serves as a ground line for the circuitry, via first and second capacitors 64, 65 respectively. Lines 611 and 612 further provide a pair of inputs to comparator 62. In essence, the comparator 62 is sensitive to changes in the relationship between its two inputs. The sensor electrodes are connected such that the relationship between the two inputs to the comparator changes when the electrical condition between the electrodes changes. As described above, this change may be generated according to whether both or only one of the electrodes are in contact with the body of a user, or according to whether the razor is immersed in water. Being sensitive to such a change, the comparator switches the motor driver circuitry 63 on. The following description is mainly in terms of the electrical condition being altered by the electrodes both touching or being in close proximity to the user's body, it being understood, as just stated, that the change in electrical condition may be brought about by other conditions.

In more detail, it will be seen in FIG. 8 that line 612 is additionally connected to one of the sensing electrodes. When there is no effective electrical connection between the two electrodes, the signals output by oscillator 61 on lines 611 and 612 have a first predetermined relationship at the input to comparator 62. When both of the sensing electrodes are in contact with the body of a user some additional electrical connection is made between line 612 and ground line 66. This may be for instance capacitance additional to capacitor 53 and/or electrical resistance. In any event the additional connection is effective to alter the characteristics of the signal on line 612 input to comparator 62. Accordingly, the relationship between the two inputs change and the comparator 62 responds by activating motor driving circuitry 63 and so motor 24.

As described above, control device 16 is responsive to both of the sensing electrodes being in contact with the body of the user. Depending upon the operating conditions of the device or the sensitivity of the comparator control device 16 may also be responsive to other conditions. In particular, if a user is holding the shaving device and is therefore in contact with one of the electrodes, it may be sufficient to bring the other electrode close to, but not touching, his or her body. The proximity of the other electrode to the body is sufficient in this case for an additional capacitance to appear between lines 612 and 66 and so cause the above described change in the signals on line 612. The sensitivity of the comparator or other circuit proximity can be set to determine the approximate distance from the body at which this effect will occur. This may for instance be set to be approximately 10 mm.

In various embodiments within this invention, variations on the arrangement of FIG. 8 are possible. As mentioned above, the invention may be configured to activate some device other than the motor 24 as well as or instead of the motor. In such a case other driving circuitry suitable for providing the current required by such other device may be provided.

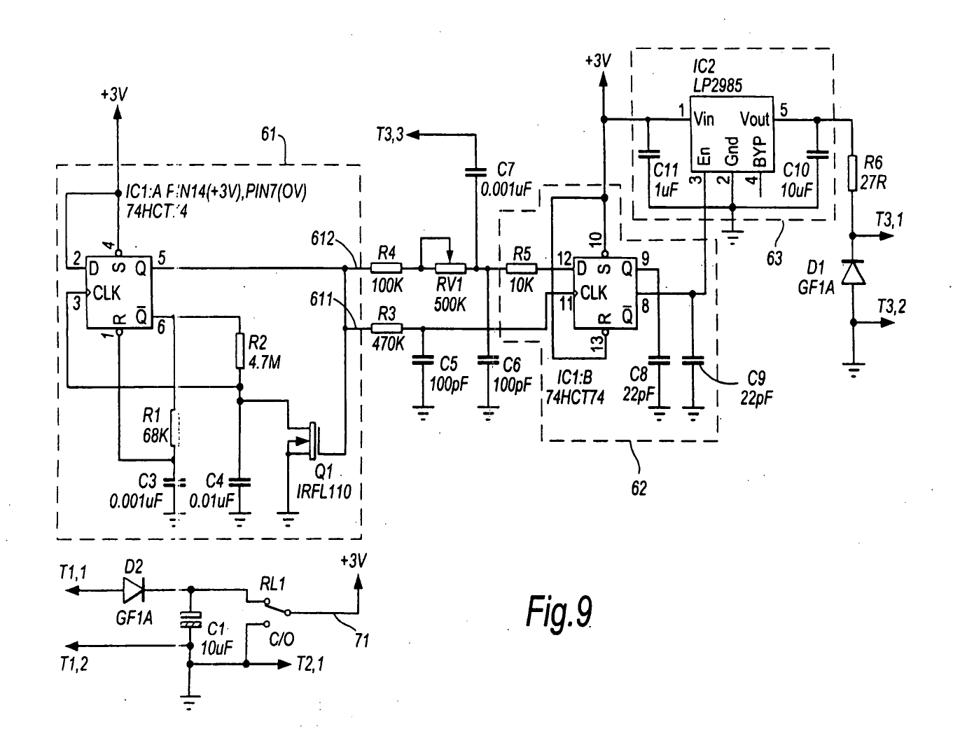

FIG. 9 illustrates a circuit implementation of the control device 16 of FIG. 8. This is shown merely by way of illustration and many other ways of implementing the functionality of the control device 16 are possible. In FIG. 9, IC1:A, IC1:B, and IC1:C are integrated circuit devices and other components are resistors, capacitors, diodes and transistors designated by the prefixes R, C, D, and Q with exemplary values being shown in the Figure.

In FIG. 9, RL1 is reed switch 20 operated by a magnet 21 in the tray 18 designed to hold the device when not in use. When the device is removed from the tray, the switch RL1 is in the position illustrated such that the power from battery 15 connected to terminals T1,1 and T1,2 is applied to the circuit via the +3V rail, 71. Terminal T2,1 is connected to the exterior casing 13 of the handle 1 of the device to provide one of the two electrodes and the “ground” for the circuit.

IC1:A forms the heart of the oscillator 61 and is configured with associated resistors R1, R2, capacitors C3, C4 and transistor Q1 to provide an oscillation output on lines 611 and 612. These provide the inputs to comparator 62, at the heart of which IC1:B, via resistor and capacitor networks R4,RV1 and C6, and R3 and C5.

Within each cycle of the oscillating signal, when the signal on line 611 goes high, capacitor C5 starts to charge via resistor R3. Therefore, a rising signal is applied to the clock input of IC1:B. At a certain level of this input signal, the clock input of IC1:B changes from low to high. The frequency of the oscillation and the charging rate of capacitor C5 are set such that the “high” clock input to IC1:B is reached during each oscillator cycle. As is well known, whenever the clock signal goes high the value of the “D” input to IC1:B is clocked through to the Q output, with Q being the inverse.

Also within each cycle of the oscillating signal, when the signal on line 612 goes high, capacitor C6 starts to charge via resistor R4 and variable resistor RV1. As capacitor C6 has the same value as capacitor C5, when nothing is connected to terminal T3,3 and RV1 is set so that the combination of R4 and RV1 is equivalent to R3, the charging rate of the two capacitors is the same. Therefore, RV1 can be used to trim the circuit to ensure that, in this condition, C6 charges at least as quickly as C5 such the when the clock input to IC1:B goes high, the ‘D’ input from line 612 is also high. In this condition Q is always low and the motor driving circuitry 63 is not enabled.

Terminal T3,3 is connected to the electrode 4 in the blade unit of the razor. Accordingly, when that electrode is brought into contact with or close proximity to the body of a user who is holding the handle connected to terminal T2,1, an additional path to ground is made, via a capacitor C7 and whatever resistance and capacitance the user's body has. This has the effect of slowing the charging rate of capacitor C6 such that, when the clock input of IC1:B goes high, the ‘D’ input is still low and so Q goes high.

Motor 24 is connected to terminals T3,1 and T3,2 and is driven by standard motor driven circuit IC2. This circuit is enabled by the value of Q of IC1:B going high, thereby activating the motor 24 when an electrical condition between the electrodes alters, for instance when the head of the device is placed against the user's skin.

As described above the control device functions so that the motor 24 stops immediately when the blade unit of the razor is moved out of contact with the skin. This is not essential and the control device can be arranged to provide a short delay of up to a few seconds, e.g. around 0.1 to 0.5 seconds, before turning off the power supply to the motor after contact between the blade unit and the skin of the user is interrupted, which may be beneficial in maintaining the vibration of the razor between shaving strokes performed in quick succession.

It should be understood that the foregoing description of various embodiments is given by way of non-limiting example only and that modifications are possible without departing from the scope of the invention as defined by the claims which follow. As an example of one possible modification, the conductive casing 13 of the handle could be provided with a thin covering layer of insulating material so that there is a high capacitance and high resistance coupling between the hand of the user and the handle electrode. Furthermore, if desired a manually operable switch mechanism can be included on the razor handle and be connected electrically in series with the switch 20, for use by a user who prefers not to use the storage tray 18 for holding the razor when it is not being used. This switch, or a different manually operable switch, such as an electronic toggle switch which turns on and/or off after a certain delay may be included in order to allow the razor user to select a non-vibrating mode, for example when trimming hair in awkward areas.

### OTHER EMBODIMENTS

A number of embodiments of the invention have been described. Nevertheless, it will be understood that various modifications may be made without departing from the spirit and scope of the invention.

What is claimed is:

1. A safety razor comprising;
a blade unit having at least one blade with a sharp cutting edge;
a handle on which the blade unit is carried;
a power switch; and
an electrical arrangement operable during shaving and connectable to a power source via the power switch, wherein the power switch is included on the razor and is arranged to be operated to permit power delivery from the power source to the electrical arrangement by separation of the razor from a holder on which the razor is stored during periods of non-use; and
a timing device to interrupt the supply of power to the electrical arrangement if the razor is not returned to the razor holder within a predetermined time period after being removed from the razor holder.

2. A safety razor of claim 1, wherein the power switch is included in the handle of the razor.

3. A safety razor of claim 2, wherein the power switch is a mechanical switch positioned on the handle to be actuated by engagement with and disengagement from the razor holder.

4. A safety razor of claim 1, wherein the power switch is magnetically actuable, and the razor holder comprises a magnet for the switch to be operated when the razor is separated from and placed onto the razor holder.

5. A safety razor of claim 4, wherein the power switch comprises a reed switch.

6. A safety razor of claim 3, wherein the razor holder is arranged to grip the handle at or adjacent to the location of the power switch.

7. A safety razor of claim 1, wherein the razor holder comprises a tray for the razor to lie on.

8. A safety razor of claim 1, wherein the electrical arrangement comprises an electrical device and a control device to control operation of the electrical device in response to a condition sensed by the control device.

9. A safety razor of claim 8, wherein the condition sensed by the control device is the blade unit being brought into contact with, or into close proximity to, the skin surface of a person holding the razor.

10. A safety razor of claim 8, wherein the condition sensed by the control device is the blade unit being immersed into a body of water.

11. A safety razor of claim 1, wherein the power source comprises a battery.

12. A safety razor of claim 11, wherein the battery is housed in the handle.

13. A safety razor of claim 1, wherein the timing device is re-settable by placing the razor onto the holder.
